(19) United States
(12) Patent Application Publication
(10) Pub. No.: US 2017/0197204 A1
(43) Pub. Date: Jul. 13, 2017

(54) METHOD FOR ELIMINATING METAL IONS FROM A VISCOUS ORGANIC SOLUTION

(71) Applicant: Arkema France, Colombes (FR)

(72) Inventors: Xavier Chevalier, Grenoble (FR); Christophe NAVARRO, Bayonne (FR); Celia COLET, Talence (FR)

(73) Assignee: Arkema France, Colombes (FR)

(21) Appl. No.: 15/314,803

(22) PCT Filed: Jun. 1, 2015
(86) PCT No.: PCT/FR2015/051427

§ 371 Date: Nov. 29, 2016

(30) Foreign Application Priority Data
Jun. 3, 2014 (FR) FR1455002

(51) Int. Cl. B01J 39/20; B01J 39/07; C08G 85/00; B01J 47/02; C08F 6/02; B01D 15/36; B01J 39/26

(52) U.S. Cl. CPC B01J 39/20; B01D 15/362; B01J 39/07; B01J 39/26; B01J 47/02; C08F 6/02; C08G 85/002

(57) ABSTRACT

The invention relates to a method for eliminating metal ions from a viscous organic solution, the viscosity of which at 20° C. is between 1 and 1000 cP. This method comprises the steps consisting in placing a macroporous ion-exchange resin in a column, said resin comprising at least one acid resin of carboxylic type, based on a copolymer having active groups in carboxylic form (CO₂H), then in continuously passing said viscous organic solution over said ion-exchange resin.

### FIELD OF THE INVENTION

The present invention relates to the purification of viscous organic solutions comprising one or more organic solvents. More particularly, a subject of the present invention is eliminating traces of metals in viscous organic liquid solutions. These traces may be in metallic, ionic, or complexed form. The viscous organic solutions may consist of a solvent or a mixture of solvents. They may also comprise one or more polymers or copolymers in solution in this (these) solvent(s).

Most commercial organic liquids and polymers or copolymers are available on the market with an already very high degree of purity, generally greater than 99 percent. However, metals in trace amounts are still found in these liquids, and polymers or copolymers, which require additional purification to enable the use thereof in industries such as the electronics industry or the pharmaceutical industry. In general, organic solvents, polymers or copolymers containing less than 100 ppb of each alkali or alkaline-earth metal contaminant would be necessary for most uses in these two technical fields (1 ppb=1 part by weight per billion).

However, in some cases, the viscosity of the solutions to be purified is such that the purification process is made very difficult.

It therefore appears desirable to have a method for purifying viscous organic solutions consisting of one or more organic solvents, and optionally one or more polymers or copolymers, when these solutions have a high viscosity, typically greater than 1 centipoise at 20° C., preferably greater than 5 centipoises at 20° C., the purification method in particular aiming to reduce the content of metal traces thereof, whether these traces are in metallic, ionic or complexed form.

### PRIOR ART

Ion-exchange resins are very commonly used nowadays to deionize water.

On the other hand, in the field of organic liquids, few studies mention their use.

Certain research studies are nonetheless found (C. A. Fleming and A. J. Monhemus, Hydrometallurgy, 4, pp. 159-167, 1979), the aim of which is to improve, by means of a solvent effect, the exchange selectivity of a number of metals with cationic resins, the final aim being to determine the conditions which allow the separation of metals by preparative ionic chromatography. These studies describe exchange isotherms, i.e. laws which govern the equilibrium between the metal ion in solution and the metal ion bound to the resin. The usual conditions of such studies consequently remain very far from a method for deionizing an organic medium, which moreover is in the presence of polymers or copolymers.

More recently, in WO9719057 there is a method for eliminating traces of metals from DMSO (dimethyl sulfoxide), from DMSO in the presence of water (EP 0882708 and EP 0878466), from DMSO mixed, or not mixed, with an organic liquid with a dielectric constant ranging from 5 to 50 and a PKₐ of greater than 2 (EP 0878454).

In patent application WO2013131762 ion-exchange resins in basic form, or in the form of a mixture of a basic resin and an acid resin, are used in order to eliminate metals from polymer-solvent solutions. However, the exemplified method describes solutions based on polymers of low molar mass (the molar mass by weight is typically of the order of 40 000 g/mol) and of low concentration (typically 2% by weight of polymer in a solvent), such that the solutions described are not viscous within the meaning of the present invention. Moreover, the exemplified method appears complicated to carry out since it consists in preparing a slurry of resins and polymer solution. To prepare this slurry, it is necessary to clean beforehand the resins used, then mix and agitate the slurry for a long time (typically for 20 hours in the examples), then it is necessary to separate the purified solution from the resins, by filtration, for example. Finally, the results obtained in the examples described in this document demonstrate a still partial decontamination for some elements such as zinc, lithium, calcium, potassium or sodium, and sometimes copper. Now, to be able to use a viscous solution in the field of electronics in particular, such as, for example, on a lithographic apparatus, there must be no exception among the contaminating elements, which must all be at as low a content as possible and preferably less than 100 ppb and even more preferentially less than 10 ppb. The method, described in this patent application, therefore has the following drawbacks:
the polymer-solvent solutions to be decontaminated comprise polymers with low molar mass and at low concentrations, such that they are slightly viscous,
the treatment times are long (around 20 hours),
an additional step of separation of resins from polymer solution is necessary,
some contaminants are only partially eliminated.

Moreover, in the field of electronics and more particularly of lithography, concentrated polymer solutions are necessary for obtaining thick films (the thickness of which is typically greater than 30 nm) after deposition by the conventional “spin coating” method. Solutions with a low concentration of polymer do not make it possible to obtain films of such thickness with the conventional equipment currently present on lithography apparatus.

For these various reasons, this method appears complicated and costly to carry out on an industrial scale and does not enable sufficient elimination of all the contaminating elements.

Documents EP1132410, EP0544324 and EP0544325 describe methods for eliminating metals from a polymer solution by placing said polymer solution in contact with a highly acid ion-exchange resin, in particular a resin of sulfonic type having a structure based on styrene-vinylbenzene. These methods make it possible to obtain satisfactory results in terms of decontamination, but the applicant has sought an alternative improved method.

### Technical Problem

The aim of the invention is therefore to have an improved method enabling the treatment of viscous organic solutions, even if just to improve the productivity of these viscous solutions consisting of solvent(s) and optionally comprising one or more polymer(s), said polymer(s) being at high concentrations in the solutions and/or having a high molar mass.

The applicant has now discovered that viscous solutions, the viscosity of which at 20° C. is between 1 and 1000 cP, possibly containing polymers or copolymers and being contaminated with metals, in metallic, ionic or complexed form, may be separated from these metals by using materials which trap these metals in metallic, ionic or complexed form, in a continuous and rapid method.

### BRIEF DESCRIPTION OF THE INVENTION

The present invention relates to a method for eliminating metal ions from a viscous organic solution, the viscosity of which at 20° C. is between 1 and 1000 cP, said method being characterized in that it comprises the steps consisting in placing a macroporous ion-exchange resin in a column, said resin comprising at least one acid resin of carboxylic type, based on a copolymer having active groups in carboxylic form (CO₂H), then in continuously passing the viscous organic solution over said ion-exchange resin.

Thus, the metals present in the viscous solution are exchanged with the protons of the acid resin, until the content of each of the metals present in solution is less than 100 ppb and preferably less than 10 ppb.

According to other optional characteristics of the method:
the resin is entirely composed of an acid resin of carboxylic type, based on a copolymer having active groups in carboxylic form (CO₂H),
the contact time between the viscous organic solution and the ion-exchange resin is between 1 minute and 12 hours, preferably between 10 minutes and 4 hours,
the ion-exchange resin has a porosity of between 100 Å and 600 Å,
the ion-exchange resin has a specific surface area of between 20 and 600 m²/g,
the ion-exchange resin has an active group concentration of between 0.7 eq/l and 10 eq/l and preferably of between 0.7 eq/l and 5 eq/l,
the viscosity of the viscous organic solution is between 5 and 1000 cP at 20° C., and even more preferably between 5 and 400 cP at 20° C.,
the viscous organic solution to be decontaminated is brought into contact with the ion-exchange resin at a temperature ranging from 18 á 120° C.,
the viscous organic solution comprises a solvent or a mixture of organic solvents,
the viscous organic solution also comprises a polymer or a mixture of polymers,
at least one other macroporous ion-exchange resin is placed in said column, said other resin being a basic resin comprising active groups either in amine form, of dimethylamino type, or in quaternary ammonium form,
the method also consists in pumping the viscous organic solution at the outlet of the column and reinjecting it at the top of the column to cause the viscous organic solution to circulate for several passes over said ion-exchange resin, until a predetermined contact time of between 1 minute and 12 hours, preferably between 10 minutes and 4 hours, is reached.

Other distinctive features and advantages of the invention will become apparent on reading the description given by way of illustrative and non-limiting example, with reference to the appended figures, which represent:

FIG. 1: curves representing the dynamic viscosity at 20° C. of an organic solution comprising an acrylic polymer, of high molar mass, at different concentrations,

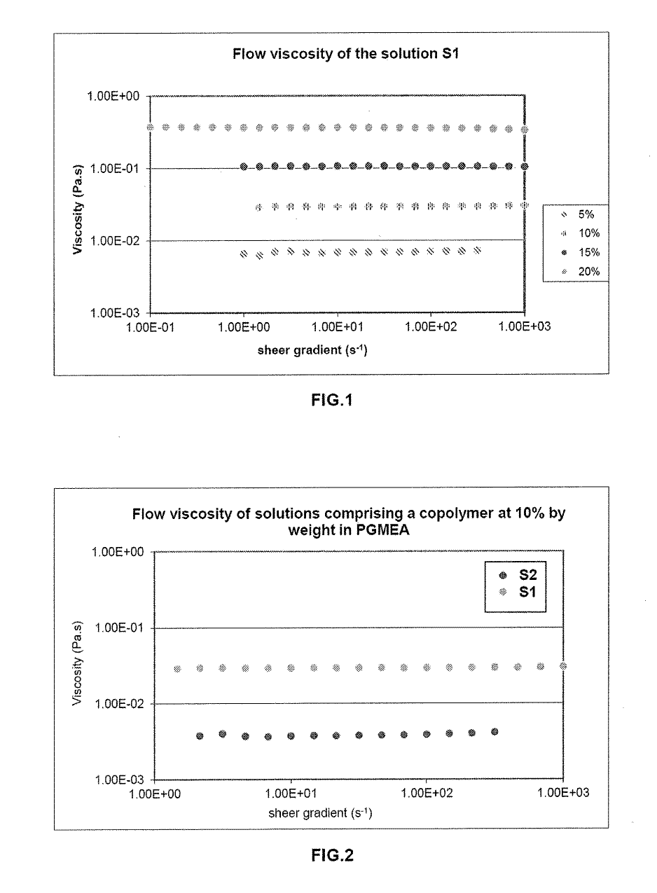

FIG. 2: two curves each representing the dynamic viscosity at 20° C. of a solution comprising a polymer, both solutions comprising an identical concentration of polymer, but the polymer of one of the solutions having a higher molar mass than the polymer of the other solution,

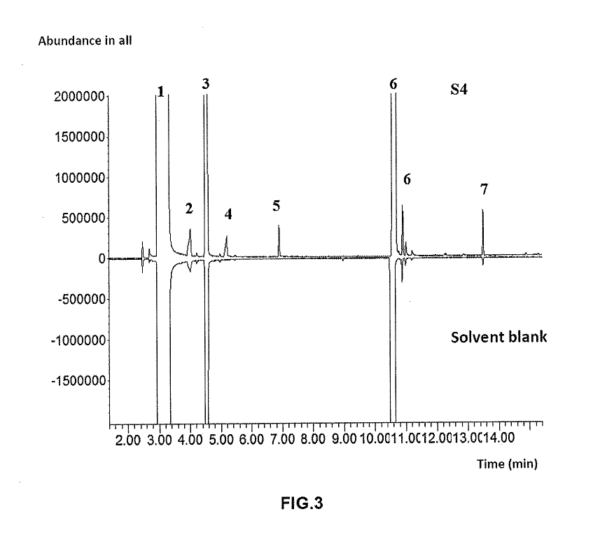

FIG. 3: mass spectra, respectively, of a polymer solution S4, after passage over a highly acid resin of sulfonic type, and a solvent blank solution.

### DETAILED DESCRIPTION OF THE INVENTION

The term “viscous organic solution” is intended to mean here an organic solution, the viscosity of which, measured at 20° C., is between 1 and 1000 cP (centipoise), preferably between 5 and 400 cP.

The term “polymer” is intended to mean either a copolymer of random, gradient, block or alternating type or a homopolymer.

The term “metals”, as used, encompasses alkali metals, alkaline-earth metals, transition metals, post-transition metals, and metalloids.

The applicant has found, in the present invention, that it is possible to eliminate the metal ions from a viscous organic solution by treating it continuously, by passing over an ion-exchange resin of acid type. Thus, any cation Mⁿ⁺ (n being an integer greater than or equal to 1) contained in the viscous organic solution is retained and exchanged with protons nH⁺ of a sulfonic resin comprising active groups in sulfonic form (SO₃H) or of a carboxylic resin comprising active groups in carboxylic form (CO₂H).

Preferably, the sulfonic or carboxylic resin is based on a polystyrene/divinylbenzene copolymer. This is because these resins have a backbone that is resistant to chemical attacks by the various organic solvents. These resins are generally defined by their divinylbenzene (DVB) content. Indeed, the latter determines the degree of crosslinking of the resin and hence the size of the pores in which the cation exchange takes place on the atomic scale. Preferably, the porosity of the sulfonic resin is between 100 and 600 Å. Such a porosity ensures good kinetic activity for the exchange of Mⁿ⁺ cations with nH⁺ cations.

In order to allow the uptake of a large amount of Mⁿ⁺ cations while avoiding saturation of the ion-exchange resin, the latter advantageously has a large specific surface area, preferably of between 20 and 600 m²/g.

Furthermore, the ion-exchange resin has an active group concentration of between 0.7 eq/l and 10 eq/l and preferably of between 0.7 eq/l and 5 eq/l.

For optimum decontamination, the contact time between the ion-exchange resin and the viscous solution should be controlled. This is because this contact time must be, on the one hand, sufficiently short for the method to be compatible with industrial use and to prevent the resin from being able to catalyze the formation of unwanted species and, on the other hand, sufficiently long for it to be possible for the viscous solution to be purified and to exhibit traces of metals of which the contents are less than 100 ppb and preferably less than 10 ppb. The contact time between the resin and the viscous organic solution depends on the temperature and on the ratio of the exchange capacity of the resin to the amount of metal cations to be exchanged, and must be greater than a minimum threshold value of 1 minute, and preferably greater than 10 minutes.

The contact time must in particular be controlled as a function of the volume of ion-exchange resin over which the viscous solution flows. Indeed, the larger the volume of resin, the more the contact time between the viscous solution and the resin can be shortened, and vice versa. This contact time must also be controlled as a function of the viscosity of the solution. Indeed, the more viscous the solution is, the more the contact time must be increased, and vice versa. Preferably, the contact time must be greater than 1 minute and less than 12 hours, and even more preferably it must be between 10 minutes and 4 hours.

In order to be able to adhere to the contact time without using columns that are too bulky, a pumping device, which makes it possible to send all the solution back to the top of the column for an additional passage over the resin, may be provided at the column outlet. Thus, it is possible to reinject the viscous solution into the column several times until the predetermined contact time, of between 1 minute and 12 hours, and preferably between 10 minutes and 4 hours, is reached.

The contact time between the viscous organic solution and the resin takes place at a temperature ranging from 18° C. to 120° C., the temperature of 120° C. being the limiting temperature for thermal stability of the resin. Preferably, the temperature is between 18 and 80° C.

In one implementation variant, the viscous solution to be decontaminated can be brought into contact with at least two ion-exchange resins, at least one of which is a resin of sulfonic or carboxylic type and the other (or others) of which is (are) a basic resin comprising active groups either in the form of a weakly basic amine of dimethylamino type, or in a strongly basic form of the quaternary ammonium type. In the case of the mixture with a basic resin, an additional effect of optional deacidification of the medium is possible.

The viscous organic solutions to be purified comprise a solvent or a mixture of solvents. They may also comprise a polymer or a mixture of polymers.

The solvent(s) may be polar or nonpolar. It (they) is (are) for example chosen from at least one of the following solvents: propylene glycol monomethyl ether acetate (PGMEA), propylene glycol methyl ether, ethyl lactate, 2-heptanone, anisole, methyl anisole, ethyl acetate, butyl acetate, butyrolactone, cyclohexanone, diethyloxylate, diethyl malonate, ethylene glycol diacetate, propylene glycol diacetate, ethyl 2-hydroxyisobutyrate and ethyl-3-hydroxypropionate, toluene, ethylbenzene, cyclohexane and tetrahydrofuran.

Any type of polymer, or mixture of polymers, that can dissolve in the solvent or mixture of solvents used may also be incorporated into the solution. The polymers may thus be copolymers of random, gradient, block or alternating type, or homopolymers.

The constituent co-monomers of the polymers that may be incorporated into the viscous solution after example chosen from the following monomers: vinyl, vinylidene, diene, olefinic, allyl or (meth) acrylic or cyclic monomers. These monomers are more particularly chosen from vinylaromatic monomers, such as styrene or substituted styrenes, in particular α-methylstyrene, silylated styrenes, acrylic monomers, such as acrylic acid or salts thereof, alkyl, cycloalkyl or aryl acrylates, such as methyl, ethyl, butyl, ethylhexyl or phenyl acrylate, hydroxyalkyl acrylates, such as 2-hydroxyethyl acrylate, ether alkyl acrylates, such as 2-methoxyethyl acrylate, alkoxy- or aryloxypolyalkylene glycol acrylates, such as methoxypolyethylene glycol acrylates, ethoxypolyethylene glycol acrylates, methoxypolypropylene glycol acrylates, methoxypolyethylene glycol-polypropylene glycol acrylates or mixtures thereof, aminoalkyl acrylates, such as 2-(dimethylamino)ethyl acrylate (ADAME), fluoroacrylates, silylated acrylates, phosphorus-comprising acrylates, such as alkylene glycol acrylate phosphates, glycidyl acrylate or dicyclopentenyloxyethyl acrylate, methacrylic monomers, such as methacrylic acid or salts thereof, alkyl, cycloalkyl, alkenyl or aryl methacrylates, such as methyl (MMA), lauryl, cyclohexyl, allyl, phenyl or naphthyl methacrylate, hydroxyalkyl methacrylates, such as 2-hydroxyethyl methacrylate or 2-hydroxypropyl methacrylate, ether alkyl methacrylates, such as 2-ethoxyethyl methacrylate, alkoxy- or aryloxypolyalkylene glycol methacrylates, such as methoxypolyethylene glycol methacrylates, ethoxypolyethylene glycol methacrylates, methoxypolypropylene glycol methacrylates, methoxypolyethylene glycol-polypropylene glycol methacrylates or mixtures thereof, aminoalkyl methacrylates, such as 2-(dimethylamino)ethyl methacrylate (MADAME), fluoromethacrylates, such as 2,2,2-trifluoroethyl methacrylate, silylated methacrylates, such as 3-methacryloylpropyltrimethylsilane, phosphorus-comprising methacrylates, such as alkylene glycol methacrylate phosphates, hydroxyethylimidazolidone methacrylate, hydroxyethylimidazolidinone methacrylate or 2-(2-oxo-1-imidazolidinyl)ethyl methacrylate, acrylonitrile, acrylamide or substituted acrylamides, 4-acryloylmorpholine, N-methylolacrylamide, methacrylamide or substituted methacrylamides, N-methylolmethacrylamide, methacrylamidopropyltrimethylammonium chloride (MAPTAC), glycidyl methacrylate, dicyclopentenyloxyethyl methacrylate, itaconic acid, maleic acid or its salts, maleic anhydride, alkyl or alkoxy- or aryloxypolyalkylene glycol maleates or hemimaleates, vinylpyridine, vinylpyrrolidinone, (alkoxy)poly(alkylene glycol) vinyl ethers or divinyl ethers, such as methoxypoly(ethylene glycol) vinyl ether or poly(ethylene glycol) divinyl ether, olefinic monomers, among which may be mentioned ethylene, butene, 1,1-diphenylethylene, hexene and 1-octene, diene monomers, including butadiene or isoprene, as well as fluoroolefinic monomers and vinylidene monomers, among which may be mentioned vinylidene fluoride, cyclic monomers, among which may be mentioned lactones, such as ε-caprolactone, lactides, glycolides, cyclic carbonates, such as trimethylene carbonate, siloxanes, such as octamethylcyclotetrasiloxane, cyclic ethers, such as trioxane, cyclic amides, such as ∈-caprolactam, cyclic acetals, such as 1,3-dioxolane, phosphazenes, such as hexachlorocyclotriphosphazene, N-carboxyanhydrides, epoxides, cyclosiloxanes, phosphorus-comprising cyclic esters, such as cyclophosphorinanes, cyclophospholanes, oxazolines, which are if appropriate protected in order to be compatible with the polymerization processes, or globular methacrylates, such as isobornyl methacrylate, halogenated isobornyl methacrylate, halogenated alkyl methacrylate or naphthyl methacrylate, alone or as a mixture of at least two abovementioned monomers.

Preferentially, the solution comprises one or more polymer(s) used in the field of lithography by direct self-assembly (DSA), such as acrylic copolymers based on styrene (S) and on methyl methacrylate (MMA), denoted PS-b-PMMA for the block copolymers or PS-stat-PMMA for the random copolymers for example.

The solution will be understood more clearly by means of the following experimental section describing an example of implementation of the present invention.

### EXPERIMENTAL Section

1. Analysis Method

An applied-stress rheometer with Couette geometry, such as the Physica MCR 301 rheometer manufactured by the company Anton Paar, was used to measure the viscosity of the organic solution. The geometry used is of aluminum concentric cylinder (Couette) type, the characteristics of which are the following:
For the spindle: diameter of 27 mm and length of 40 mm,
For the vessel: diameter of 29 mm and depth of 67 mm.

The reference of the vessel/spindle assembly is denoted CC27. The temperature is ensured by the Peltier effect and set at 20° C. The shear gradient range varies from 0.1 to 1000 s⁻¹ with a logarithmic variation and measurement of 6 points per decade.

In order to analyze the traces of metals in the viscous organic solution, two spectrometry methods were used: ICP-AES (for “Inductively Coupled Plasma—Atomic Emission Spectroscopy”) and ICP-MS (for “Inductively Coupled Plasma—Mass Spectrometry”).

The ICP-AES (inductively coupled plasma—atomic emission spectroscopy) analysis consists in introducing the sample, in powder form, into a plasma torch. The various elements present are excited and emit photons of which the energy is characteristic of the element since it is defined by the electronic structure of the element under consideration. An ICP-AES instrument from Perkin Elmer, reference 4300 DV, was routinely used.

The ICP-MS (inductively coupled plasma—mass spectrometry) analysis consists in introducing the sample in solution into a vaporization chamber where a nebulizer converts it into a liquid aerosol composed of microdroplets using argon gas. The aerosol thus formed is sent into an argon plasma torch at very high temperature, sufficient to completely vaporize, dissociate, atomize and ionize most elements. The ions are then extracted, by a series of cones, to a mass spectrometer which makes it possible to separate and quantify the various ions. An ICP-MS instrument from Agilent, reference 7500 CE, and an ICP-MS from Perkin Elmer, reference NexION™300 S, were routinely used.

2. Methodology

Principle: the metallic traces are in Mn⁺ form. The Mn⁺ ions in solution are replaced by n H⁺ ions by passing the viscous organic solution over the cation-exchange resin.

3. Tests

### Example 1: Range of Viscosities Studied

The viscosity of two organic solutions comprising a solvent and copolymers was measured at 20° C., according to, on the one hand, the copolymer concentration in the solvent and, on the other hand, the molar mass of the copolymer. The viscosity of these two solutions was also compared with the viscosity of the solvent alone.

The copolymers introduced into the solutions studied are acrylic copolymers, of PS-/PMMA, of different composition, molar mass and structure.

A first solution studied, referenced S1 in table I below and in FIGS. 1 and 2, comprises electronic-grade PGMEA mixed with a PS-b-PMMA block copolymer produced by the company Arkema. This copolymer has a high molar mass by weight (Mw) that is equal to 162.4 kg/mol, a dispersity index of 1.35, a percentage by weight of PS of 68.8% and a percentage by weight of PMMA of 31.2%. The viscosity at 20° C. of this first solution S1 was measured as a function of the block copolymer concentration in the solution, the concentration varying between 5% and 20% by weight of the solution. The results of these measurements are reported in table I below and on the curves of FIG. 1. The higher the polymer concentration in the solution, the more the viscosity increases. Depending on the polymer concentration in the solution, the viscosity of the solution varies between 6 cP and 400 cP.

The viscosity of this first solution S1, when the polymer concentration is equal to 10% by weight, was compared with the viscosity of a second solution, referenced S2 in table I below and in FIG. 2, comprising electronic-grade PGMEA mixed with a PS-stat-PMMA random copolymer produced by the company Arkema. This copolymer has a low molar mass by weight (Mw) that is equal to 9.9 kg/mol, a dispersity index of 1.34, a percentage by weight of PS equal to 67.6% and a percentage by weight of PMMA equal to 32.4%. The solution S2, the viscosity of which is compared with that of the solution S1 at 10% by weight of copolymer, is thus prepared with an identical polymer concentration, i.e. equal to 10% by weight of copolymer in the solution. The results of these measurements are reported in table I below and on the curves of FIG. 2. It results from these measurements that the viscosity increases as the molar mass of the polymer in solution increases.

TABLE I

| | Mw | | | | | |
|---|---|---|---|---|---|---|
| | (kg/mol) | | | | | Viscosity |
| Organic | Copoly- | Disper- | % m | % m | % in | at 20° |
| solution | mer | sity | PS | PMMA | PGMEA | C. (cP) |
| PGMEA | | | | | 0% | 0.8 |
| alone | | | | | | |
| S1 | 162.4 | 1.35 | 68.8 | 31.2 | 5% | 6.91 |
| | 162.4 | 1.35 | 68.8 | 31.2 | 10% | 29.7 |
| | 162.4 | 1.35 | 68.8 | 31.2 | 15% | 106 |
| | 162.4 | 1.35 | 68.8 | 31.2 | 20% | 369 |
| S2 | 9.9 | 1.34 | 67.6 | 32.4 | 10% | 3.87 |

### Example 2: Metal Decontamination

The ion-exchange resin used to carry out the decontamination of viscous solutions is a sulfonic acid resin comprising sulfonic active groups SO₃H. More particularly, in one example, the resin used may be the Amberlyst® 15 Dry resin sold by the company Rohm & Haas. This resin is very acid and comprises active groups in sulfonic form SO₃H. It comprises a matrix based on macro-crosslinked styrene-divinylbenzene and as a specific surface area equal to 53 m²/g and pore diameters of 300 Å.

This resin makes it possible to decontaminate viscous solutions of metals. It makes it possible in particular, but not exclusively, to remove the following metals: Cr, Mn, Ag, Sn, Ba, Al, Mg, Ti, Zn, Fe, K, As, W, Li, V, Co, Ni, Cu, Mo, Cd, Au, Pb, Ca, B, Na, Te.

This Amberlyst® 15 Dry resin is deposited in a column and compacted such that it forms neither air bubbles nor cracks, capable of creating a preferential path for the viscous solution. A filter placed at the bottom of the column makes it possible to separate the purified viscous solution from the resin. Prior to bringing the viscous solution into contact, methanol is passed over the resin in order to clean it until the solvent emerges colorless. The solvent of the viscous solution, which is PGMEA alone in this example, is then passed over the column in order to remove the methanol. Finally, the viscous solution of polymer is passed over the resin. During this procedure, it is preferable not to let the resin dry.

In order to allow optimum decontamination of the viscous solution, the contact time between the resin and the viscous solution should be controlled, as a function of the volume of resin used and of the viscosity of the viscous solution to be decontaminated. For this, help can be obtained from graphs which make it possible to know the relationship between the volume of resin, the viscosity of the solution and the contact time, in order to have the best possible control of the flow rate of the viscous solution introduced into the column so that it is in contact with the resin for the desired contact time. Preferably, the contact time should be between 1 minute and 12 h, and even more preferably between 10 minutes and 4 h.

In order to be able to adhere to the contact time without using columns that are too bulky, it is possible to provide, at the column outlet, a pumping device, which makes it possible to send all the solution back to the top of the column for an additional passage over the resin. Thus, it is possible to reinject the viscous solution into the column several times until the predetermined contact time is reached. Since the resin has a very large specific surface area (53 m²/g), it can capture Mn⁺ metal ions from the solution over the course of several passages without saturating.

In order to carry out these analyses, samples of the viscous solution at the column outlet are taken at regular intervals. A small amount of polymer in powder form is recovered by precipitation of the viscous solution of PGMEA from methanol and then dried.

Three viscous solutions were particularly studied.

The first solution, referenced S3, comprises electronic-grade PGMEA mixed with a PS-b-PMMA copolymer produced by the company Arkema, of which the the molar mass by weight is equal to 57.7 kg/mol, the dispersity index is equal to 1.09, the percentage by weight of PS is equal to 67.2% and the percentage by weight of PMMA is equal to 32.8%.

A second solution studied, referenced S4, comprises electronic-grade PGMEA mixed with a PS-b-PMMA copolymer produced by the company Arkema, of which the the molar mass by weight is equal to 80.6 kg/mol, the dispersity index is equal to 1.14, the percentage by weight of PS is equal to 47.9% and the percentage by weight of PMMA is equal to 52.1%.

A third solution studied, referenced S5, comprises electronic-grade PGMEA mixed with a PS-b-PMMA copolymer produced by the company Arkema, of which the the molar mass by weight is equal to 43.2 kg/mol, the dispersity index is equal to 1.10, the percentage by weight of PS is equal to 41.9% and the percentage by weight of PMMA is equal to 58.1%.

The dielectric constants of the constituents of the two solutions are the following:
PGMEA: 8.3
PS: 2.49-2.55 (1 kHz at ambient temperature)
PMMA: 3.0 (1 kHz at ambient temperature)

For each of the viscous solutions S3, S4 and S5, the solution was prepared at 10% by weight of polymer in the PGMEA.

Only the solution S4 was brought into contact with the sulfonic resin. The other solutions, S3 and S5, were subjected to a simple precipitation from methanol, followed by washing with deionized water and with methanol. The metallic traces of the three solutions were then measured and compared.

The ICP-MS or AES analyses of the polymers, in powder form, after passage over the Amberlyst resin for the solution S4, or after simple precipitation of the solutions S3 and S5 from methanol, revealed that the viscous solution S4 passed over the resin is correctly decontaminated, all the contaminants being present at very low amounts, less than 10 ppb, contrary to the solutions S3 and S5 having not been brought into contact with the resin.

Furthermore, the contact time between the viscous solution and the resin is very important for obtaining optimum decontamination. Thus, the applicant noticed that, for optimum decontamination of the viscous solution S4, the contact time must be greater than 1 minute and preferably greater than 10 minutes. Furthermore, in order to prevent any formation of unwanted species owing to catalysis by the resin, the contact time must also be less than 12 hours and even more preferably less than 4 hours.

### Example 3: Metal Decontamination on Weakly Acid Resin

The ion-exchange resin used to carry out the decontamination of viscous solutions is an acrylic acid resin comprising carboxylic active groups CO₂H. More particularly, in one example, the resin used may be the Purolite® C104Plus resin sold by the company Purolite. This resin is weakly acid and comprises active groups in carboxylic form CO₂H. It comprises a crosslinked poly(acrylic acid)-based matrix and has a particle size distribution of between 300 and 1600 μm.

300 grams of Purolite® C104Plus resin are deposited in a column and compacted such that said resin forms neither air bubbles nor cracks, capable of creating a preferential path for the viscous solution.

A filter placed at the bottom of the column makes it possible to separate the purified viscous solution from the resin. Prior to bringing the viscous solution into contact, methanol is passed over the resin in order to clean it and dehydrate it until the solvent emerges colorless. The solvent of the viscous solution, which is PGMEA alone in this example, is then passed over the column in order to remove the methanol. Finally, the viscous solution of polymer is passed over the resin at a flow rate of 0.8 l/h. During this procedure, it is preferable not to let the resin dry.

In order to allow optimum decontamination of the viscous solution, the contact time between the resin and the viscous solution should be controlled, as a function of the volume of resin used and of the viscosity of the viscous solution to be decontaminated. For this, help can be obtained from graphs which make it possible to know the relationship between the volume of resin, the viscosity of the solution and the contact time, in order to have the best possible control of the flow rate of the viscous solution introduced into the column so that it is in contact with the resin for the desired contact time. Preferably, the contact time should be between 1 minute and 12 h, and even more preferably between 10 minutes and 4 h.

In order to be able to adhere to the contact time without using columns that are too bulky, it is possible to provide, at the column outlet, a pumping device, which makes it possible to send all the solution back to the top of the column for an additional passage over the resin. Thus, it is possible to reinject the viscous solution into the column several times until the predetermined contact time is reached. Since the resin has a very large specific surface area (between 20 and 600 m²/g), it can capture Mn⁺ metal ions from the solution over the course of several passages without saturating.

In order to carry out these analyses, samples of the viscous solution at the column outlet are taken at regular intervals. A small amount of polymer in powder form is recovered by precipitation of the viscous solution of PGMEA from methanol and then dried.

A solution, referenced S6 in table II below, comprises electronic-grade PGMEA mixed with a PS-b-PMMA copolymer produced by the company Arkema, of which the the molar mass by weight is equal to 44.9 kg/mol, the dispersity index is equal to 1.10, the percentage by weight of PS is equal to 43.1% and the percentage by weight of PMMA is equal to 56.9%.

The viscous solution S6 was prepared at 4% by weight of polymer in PGMEA.

The solution S6 was brought into contact with the polyacrylic resin. The metallic traces of the solution were then measured and compared with the metallic traces measured for the other solutions, S3, S4 and S5, of the previous example, which were not brought into contact with a resin (for S3 and S5) or which were brought into contact with a strongly acid resin of sulfonic type (for S4). The results of the comparisons are collated in table II below.

The ICP-MS or AES analyses of the polymers, in powder form, after passage over the Purolite® resin for the solution S6 reveal that the viscous solution S6 passed over the resin is correctly decontaminated, all the contaminants being present at very low amounts, less than 10 ppb, contrary to the solutions S3 and S5 having not been brought into contact with the resin.

### Example 4: Metal Decontamination on a Mixture of Resins Containing a Weakly Acid Resin

The ion-exchange resin used to carry out the decontamination of viscous solutions is an equal-weight mixture of Amberlyst® 15 Dry resin (150 g), sold by the company Rohm & Haas, described in example 2, and of Purolite® C104Plus resin (150 g), sold by the company Purolite described in example 3.

This mixture of resins is conditioned according to the procedures described in examples 2 and 3.

A solution, referenced S7 in table II below, prepared in a manner identical to that of the solution S6 described in example 3, was brought into contact with the equal—weighted mixture of resins, at a flow rate of 0.8 l/h. The metallic traces of the solution S7 were then measured and compared with the metallic traces measured for the other solutions, S3, S4, S5 and S6, of the previous examples 2 and 3, which were not brought into contact with a resin (for S3 and S5) or which were brought into contact with a strongly acid resin of sulfonic type (for S4) or into contact with a weakly acid resin of carboxylic type (for S6). The results of the comparisons are collated in table II below.

The ICP-MS or AES analyses of the polymers, in powder form, after passage over the mixture of resins for the solution S7 reveal that the viscous solution S7 passed over the mixture of resins is correctly decontaminated, all the contaminants being present at very low amounts, less than 10 ppb, contrary to the solutions S3 and S5 having not been brought into contact with the resin.

Table II below groups together the results obtained by ICP-MS: all of the values given correspond to polymer solutions passed at 1.4% in PGMEA.

TABLE II

| | Results S3 | Results S4 | Results S5 | Results S6 | Results S7 |
|---|---|---|---|---|---|
| Metals | (ppb) | (ppb) | (ppb) | (ppb) | (ppb) |
| Li | 43 | <1 | 32 | <1 | <1 |
| Na | 21 | 2 | 18 | 3 | 2 |
| Fe | 3 | <1 | 2 | <1 | <1 |
| Mn | <1 | <1 | <1 | <1 | <1 |
| Sn | <1 | <1 | <1 | <1 | <1 |
| Pb | <1 | <1 | <1 | <1 | <1 |
| Mo | <1 | <1 | <1 | <1 | <1 |
| K | 16 | <1 | 23 | 2 | 1 |
| Zn | <1 | <1 | <1 | <1 | <1 |
| Cu | <1 | <1 | <1 | <1 | <1 |
| Co | <1 | <1 | <1 | <1 | <1 |
| Ni | 8 | <1 | 4 | <1 | <1 |
| Mg | <1 | <1 | <1 | <1 | <1 |
| Al | 13 | 2 | 11 | 3 | 2 |
| Cr | <1 | <1 | <1 | <1 | <1 |
| Ca | 27 | 2 | 25 | 4 | 2 |

Furthermore, the applicant noticed that the polymer solutions S6 and S7 did not smell of the acid after passage over a decontamination column, contrary to the solution S4. An analysis by gas chromatography coupled to mass spectrometry (also denoted “analysis by GC/MS coupling”) was carried out to determine the content of residual molecules in this solution S4, contrary to the solutions S6 and S7.

1. Sample Preparation

Given the small amount of sample, the precipitation of the polymer is carried out in a small flask, generally crimped, more commonly known as a “vial”, of 2 ml.

Around 50 mg of sample to be analyzed are very exactly weighed out, and 200 μl of dichloromethane are added thereto. Once the sample has dissolved, the polymer is precipitated by adding 1400 μl of methanol. The solution is stirred and filtered on a 0.45 μm PTFE disk in a 2 ml vial equipped with an insert of 250 μl for injection of small volumes.

The filtrate is injected by means of an automatic sample changer, and analyzed by GC/MS coupling.

2. Preparation of a Sample with Addition

Around 50 mg of sample to be analyzed are very exactly weighed out, and 150 μl of dichloromethane+50 μl of a dilute solution of toluene are added thereto. Once the sample has dissolved, the polymer is precipitated by adding 1400 μl of methanol. The solution is stirred and filtered on a 0.45 μm PTFE disk in a 2 ml vial equipped with an insert of 250 μl for injection of small volumes.

The filtrate is injected by means of an automatic sample changer, and analyzed by GC/MS coupling.

3. Preparation of a Solvent Blank

A mixture is prepared with 50 μl of PGMEA, 200 μl of dichloromethane and 1400 μl of methanol.

The mixture is filtered on a 0.45 μm PTFE disk.

4. Standard Solution Preparation

Standard solutions of acetic acid and of 2-methoxyethanol at approximately 10, 50 and 100 μg/ml in a methanol/dichloromethane mixture are prepared by successive dilutions from a stock solution.

Table III below summarises the various identifications carried out.

The expanded formulae correspond to the structures having the best compatibility with the fragmentation is observed in the electron ionization (EI+) mass spectra of FIG. 3, which represents, in the upper part, the spectrum of the sample of solution S4 after passage over a strongly acid resin of sulfonic type and, in the lower part, the spectrum of the solvent blank. However, other isomeric structures are not to be excluded.

The Nos. of the peaks refer back to the chromatographic profiles.

The semi-quantitative determinations, expressed as % by weight, are obtained by external calibration:
The acetic acid is measured relative to its own calibration line.
The 1-methoxy-2-propanol and the 1,2-propanediol diacetate are evaluated relative to the calibration line of a 2-methoxyethanol standard.

TABLE III

| Peak | | | Molecular | S4 |
|---|---|---|---|---|
| No. | Structure proposal | Mw | formula | (% by weight) |
| 1 | Methanol (solvent) | 32 | CH4O | |
| 2 | Acetonitrile (rinsing solvent) | 41 | C2H3N | |
| 3 | Dichloromethane (solvent) | 84 | CH2Cl2 | |
| 4 | Acetic acid | 60 | C2H4O2 | 0.7 |
| 5 | 1-Methoxy-2-propanol | 90 | C4H10O2 | 0.5 |
| 6 | PGMEA (several isomers) | 132 | C6H12O3 | |
| 7 | 1,2-Propanediol diacetate | 160 | C7H12O4 | 0.5 |

The solution S4 after passage over a sulfonic acid resin contains acetic acid, 1-methoxy-2-propanol and 1,2-propanediol diacetate, contrary to the solutions S6 and S7 passed over carboxylic resins or over a mixture of resins containing at least one carboxylic resin. Consequently, the use of a weakly acid resin, of carboxylic, makes it possible to cause less degradation to the quality of a solution containing a compound sensitive to strong acids, such as PGMEA.

1. A method for eliminating metal ions from a viscous organic solution, comprising a solvent or a mixture of organic solvents and a polymer or a mixture of polymers, the viscosity of which at 20° C. is between 1 cP and 1000 cP, wherein said method comprises placing a macroporous ion-exchange resin in a column, said resin comprising at least one acid resin of carboxylic type, based on a polystyrene divinylbenzene copolymer having active groups in carboxylic form (CO₂H), then continuously passing the viscous organic solution over said ion-exchange resin.

2. The method as claimed in claim 1, wherein the resin is entirely composed of an acid resin of carboxylic type, based on a copolymer having active groups in carboxylic form (CO₂H).

3. The method as claimed in claim 1, wherein the contact time between the viscous organic solution and the ion-exchange resin is between 1 minute and 12 hours.

4. The method as claimed in claim 1, wherein the ion-exchange resin has a porosity of between 100 Å and 600 Å.

5. The method as claimed in claim 1, wherein the ion-exchange resin has a specific surface area of between 20 and 600 m²/g.

6. The method as claimed in claim 1, wherein the ion-exchange resin has an active group concentration of between 0.7 eq/l and 10 eq/l.

7. The method as claimed in claim 1, wherein the viscosity of the viscous organic solution is between 5 and 400 cP at 20° C.

8. The method as claimed in claim 1, wherein the viscous organic solution to be decontaminated is brought into contact with the ion-exchange resin at a temperature ranging from 18° C. to 120° C.

9. The method as claimed in claim 1, wherein at least one other macroporous ion-exchange resin is placed in said column, and wherein said other resin is a basic resin comprising active groups either in amine form, of dimethylamino type, or in quaternary ammonium form.

10. The method as claimed in claim 1, additionally comprising a step of pumping the viscous organic solution at the outlet of the column and reinjecting it at the top of the column to cause the viscous organic solution to circulate for several passes over said ion-exchange resin, until a predetermined contact time of between 1 minute and 12 hours.

11. The method as claimed in claim 1, wherein the contact time between the viscous organic solution and the ion-exchange resin is between 10 minutes and 4 hours.

12. The method as claimed in claim 1, wherein the ion-exchange resin has an active group concentration of between 0.7 eq/l and 5 eq/l.
